(19) United States
(12) Patent Application Publication
(10) Pub. No.: US 2013/0283318 A1
(43) Pub. Date: Oct. 24, 2013

(54) Dynamic Mosaic for Creation of Video Rich User Interfaces

(71) Applicant: Jeffrey Ronald Wannamaker, London (CA)

(72) Inventor: Jeffrey Ronald Wannamaker, London (CA)

(73) Assignee: COMCAST CABLE COMMUNICATIONS, LLC., Philideplhia, PA (US)

(21) Appl. No.: 13/453,246

(22) Filed: Apr. 23, 2012

(51) Int. Cl. H04N 21/482

(52) U.S. Cl. 725/56

(57) ABSTRACT

Systems and methods for delivering video content for use in video rich user interfaces are disclosed. A mosaic channel may be generated, comprised of multiple video tiles each located at a different position within the mosaic channel, and transmitted to a receiving device. Audio for each video tile may also be provided. The receiving device may, using a 3D graphics engine (e.g., OpenGL), generate a video rich user interface navigable by a user to preview any of the different videos or other content included within the mosaic channel. The content included within the mosaic channel may be altered as the user is navigating the video rich user interface so that the user can continuously preview different content.

### FIELD

Aspects described herein are directed to media distribution networks such as distribution systems. Some aspects relate to methods and systems for using dynamically generated mosaic channels to communicate multiple video programs to a device. Some aspects relate to generation of video rich user interfaces using dynamically generated mosaic channels.

### BACKGROUND

Video distribution systems may operate by allowing multiple streams of content to be sent downstream via multiplexing. For digital television channels, through multiplexing, each physical radio frequency (RF) channel may carry several digital streams of video programming material from different services or content providers (e.g., HBO, CBS, ESPN, etc.). Traditionally an end user can only see as many video programs on a screen at one time as there are tuners available on the respective system. Stated differently, an end user traditionally needs two tuners to display two streams of video on a screen simultaneously (e.g., as with picture-in-picture) because each tuner is configured to only locate and decode one of the streams in the channel, even if multiple streams are multiplexed in that channel. For example, if a multiplexed signal on a single physical RF channel included a program stream for one content service (e.g., ESPN) and a program stream for another content service (e.g., NBC), an end user would still need at least two tuners or decoders associated with her media receiving device to simultaneously display both programs. As a result of these and other factors, video rich user-interfaces, e.g., user interfaces with multiple distinct full-motion videos presented at the same time, may be limited and improvements are desired.

### SUMMARY

The following presents a simplified summary of the present disclosure in order to provide a basic understanding of some features of the disclosure. This summary is provided to introduce some concepts in a simplified form that are further described below. This summary is not intended to identify key features or essential features of the disclosure.

According to a first aspect, a method for rendering a video rich user interface includes receiving a mosaic signal or feed, e.g., as a channel, comprising a first plurality of video tiles, each video tile corresponding to a video program. A mosaic channel generally refers to a channel comprised of multiple smaller versions of video content, such as is illustrated in FIGS. 4-5. The method further includes generating a navigable user interface having a plurality of video display areas, wherein the number of video display areas may be no greater than the number of video tiles. One or more of the plurality of video tiles are mapped to a different one of the plurality of video display areas, and the user interface may be rendered in a simulated three dimensional graphical environment (e.g., an environment that uses a three-dimensional representation of geometric data stored in the computer for purposes of performing calculations and rendering 2D images). Each of the plurality of video display areas corresponds to a surface of a polygon within the simulated three dimensional graphical environment. The user interface thereby concurrently plays the video programs corresponding to the plurality of video display areas.

According to some aspects, audio corresponding to a video program in a primary focus video display area may be output. According to other aspects, a device rendering the user interface may send feedback to a device associated with generating the mosaic channel, where the feedback is based on user navigation of the user interface. The mosaic channel may subsequently be modified based on the user feedback to provide new or different video programs.

In still other aspects, the user interface may include a three dimensional control object displaying the plurality of video display areas in a predetermined sequence, and the method may further include sequentially mapping the video tiles to the sequenced plurality of video display areas as the user navigates the three dimensional control object to allow the user to preview the plurality of video programs.

The mapping of the video tiles may be looped, e.g., by repeating a selected first video tile after a selected last video tile, to provide an endless display of video programs on the three dimensional control object. Alternatively, where a modified mosaic channel has been received based on navigational feedback, the rendering device may map newly added video tiles to the video display areas to provide new video programs for preview by a user.

A content distribution center (e.g., a computing device, a headend, local office, or other central location), may generate each mosaic channel based on a predetermined set of video content, or based on video content matching the desired characteristic. For example, a user may specify a desired characteristic, such as a genre of video programs (sports, comedies, reality TV, etc.), a popularity (most watched today, most watched within the past week, most watched dramas, most watched ever, most watched by friends, etc.), and previously watched content (e.g., recently viewed channels, episodes of recently viewed series, etc.).

According to other aspects, devices that perform one or more steps of the method are also described, as well as storage devices storing computer readable instructions that, when executed, cause one or more devices to execute the described methods. These and other aspects will be readily apparent upon reading the entire description below.

### BRIEF DESCRIPTION OF THE DRAWINGS

Some embodiments of the present disclosure are illustrated by way of example, and not by way of limitation, in the figures of the accompanying drawings and in which like reference numerals refer to similar elements.

FIG. 1 illustrates an example network on which various features herein may be implemented;

FIG. 2 illustrates an example premises with a gateway and various communication devices;

FIG. 3 illustrates an example computing device on which various features described herein may be implemented;

FIG. 4 illustrates a mosaic channel layout according to various aspects described herein;

FIG. 5 illustrates a still image from a mosaic channel according to various aspects described herein;

FIG. 6 illustrates a schematic diagram of a content reception device according to various aspects described herein;

FIG. 7 illustrates a mapping of video tiles to a three dimensional control object according to various aspects described herein.

FIG. 8 illustrates a video rich user interface according to various aspects described herein.

FIG. 9 illustrates a method for generating and displaying content based on a dynamic mosaic channel according to various aspects described herein.

FIG. 10 illustrates a mosaic channel having differently sized video tiles according to various aspects described herein.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized and structural and functional modifications may be made.

The disclosure may be operational with numerous general purpose or special purpose computing system environments or configurations. Examples of computing systems, environments, and/or configurations that may be suitable for use with features described herein include, but are not limited to, personal computers, server computers, hand-held or laptop devices, multiprocessor systems, microprocessor-based systems, set top boxes, digital video recorders, programmable consumer electronics, network PCs, minicomputers, mainframe computers, distributed computing environments that include any of the above systems or devices, and the like.

The features may be described and implemented in the general context of computer-executable instructions, such as program modules, being executed by a computer. Generally, program modules include non-transitory software, routines, programs, objects, components, data structures, etc. that, when executed by a data processing device, perform particular tasks or implement particular abstract data types. Features herein may also be practiced in distributed computing environments where tasks are performed by remote processing devices that are linked through a communications network. In a distributed computing environment, program modules may be located in both local and remote computer storage media including memory storage devices.

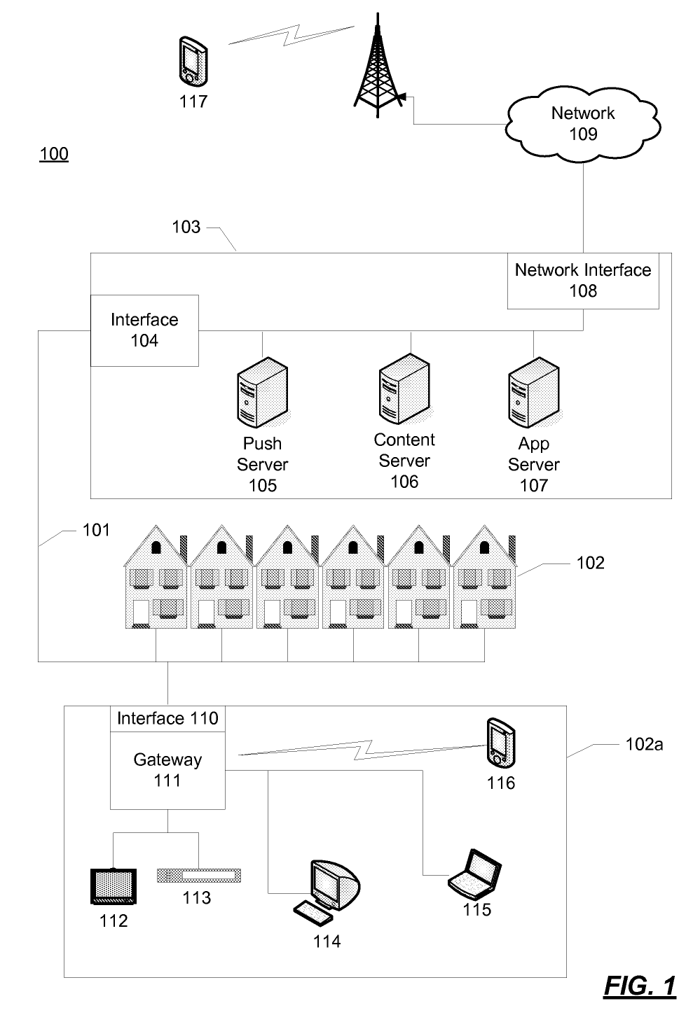

FIG. 1 illustrates an example information distribution network 100 on which many of the various features described herein may be implemented. Network 100 may be any type of information distribution network, such as satellite, telephone, cellular, wireless, etc. One example may be an optical fiber network, a coaxial cable network or a hybrid fiber/coax distribution network. Such networks 100 use a series of interconnected communication links 101 (e.g., coaxial cables, optical fibers, wireless, etc.) to connect multiple premises 102 (e.g., businesses, homes, consumer dwellings, etc.) to a local office 103 (e.g., a central office, headend, or other service facility). The local office 103 may transmit downstream information signals onto the links 101, and each premises 102 may have a receiver used to receive and process those signals.

There may be one link 101 originating from the local office 103, and it may be split a number of times to distribute the signal to various premises 102 in the vicinity (which may be many miles) of the local office 103. The links 101 may include components not illustrated, such as splitters, filters, amplifiers, etc. to help convey the signal clearly, but in general each split introduces a bit of signal degradation. Portions of the links 101 may also be implemented with fiber-optic cable, while other portions may be implemented with coaxial cable, other lines, or wireless communication paths.

The local office 103 may include an interface 104, such as a termination system (TS) or a cable modem termination system (CMTS), which may be a computing device configured to manage communications between devices on the network of links 101 and backend devices such as servers 105-107 (to be discussed further below). The interface 104 may be as specified in a standard, such as the Data Over Cable Service Interface Specification (DOCSIS) standard, published by Cable Television Laboratories, Inc. (a.k.a. CableLabs), or it may be a similar or modified device instead. The interface 104 may be configured to place data on one or more downstream frequencies to be received by corresponding interfaces 110 (e.g., corresponding modems) at the various premises 102, and to receive upstream communications from those modems on one or more upstream frequencies. The local office 103 may also include one or more network interfaces 108, which can permit the local office 103 to communicate with various other external networks 109. These networks 109 may include, for example, networks of Internet devices, telephone networks, cellular telephone networks, fiber optic networks, local wireless networks (e.g., WiMAX), satellite networks, and any other desired network, and the interface 108 may include the corresponding circuitry needed to communicate on the network 109, and to other devices on the network such as a cellular telephone network and its corresponding cell phones.

As noted above, the local office 103 may include a variety of servers 105-107 that may be configured to perform various functions. For example, the local office 103 may include a push notification server 105. The push notification server 105 may generate push notifications to deliver data and/or commands to the various premises 102 in the network (or more specifically, to the devices in the premises 102 that are configured to detect such notifications). The local office 103 may also include a content server 106. The content server 106 may be one or more computing devices that are configured to provide content to users in the homes. This content may be, for example, video on demand movies, television programs, songs, text listings, etc. The content server 106 may include software to validate user identities and entitlements, locate and retrieve requested content, encrypt the content, and initiate delivery (e.g., streaming) of the content to the requesting user and/or device.

The local office 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide or interactive program guide listings. Another application server may be responsible for monitoring user viewing habits and collecting that information for use in selecting advertisements. Another application server may be responsible for formatting and inserting advertisements in a video stream being transmitted to the premises 102. Another application server may be responsible for receiving user remote control commands, and processing them to provide an intelligent remote control experience.

An example premises 102a may include an interface 110, such as a modem, which may include transmitters and receivers used to communicate on the links 101 and with the local office 103. The modem 110 may be, for example, a coaxial cable modem (for coaxial cable lines 101), a fiber interface node (for fiber optic lines 101), or any other desired modem device. The modem 110 may be connected to, or be a part of, a gateway interface device 111. The gateway interface device 111 may be a computing device that communicates with the modem 110 to allow one or more other devices in the premises 102a to communicate with the local office 103 and other devices beyond the local office. The gateway 111 may be a set-top box (STB), digital video recorder (DVR), computer server, or any other desired computing device. The gateway 111 may also include (not shown) local network interfaces to provide communication signals to devices in the premises 102a, such as televisions 112, additional STBs 113, personal computers 114, laptop computers 115, wireless devices 116 (wireless laptops, tablet computers and netbooks, mobile phones, mobile televisions, personal digital assistants (PDA), etc.), and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11), Bluetooth interfaces, and others.

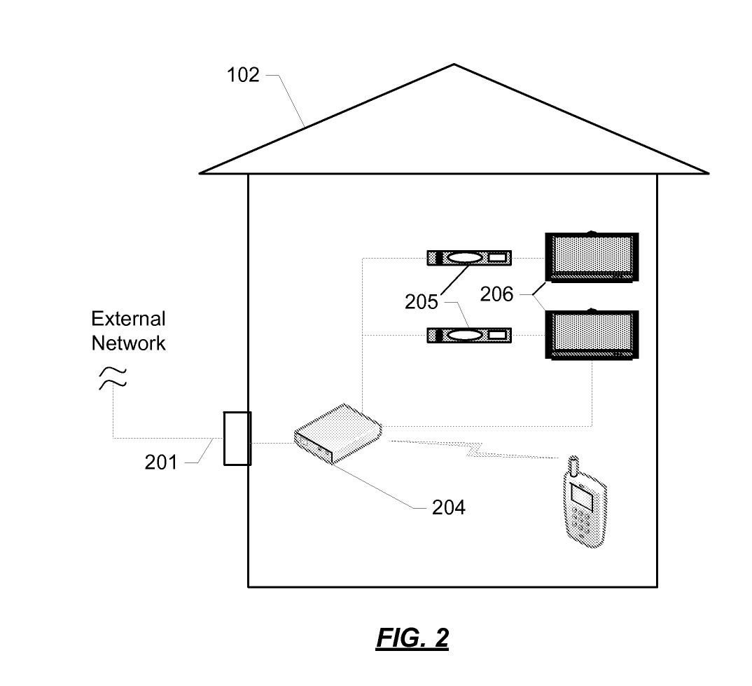

FIG. 2 illustrates a closer view of a premises 102 (e.g., home, business, institution, etc.) that may be connected to the network 101 via an interface 201. A communication line (coaxial, fiber, wireless, etc.) may be connected to a gateway device, e.g., device 204. The gateway 204 may be a computing device configured to communicate over the network 101 and with the central location 103. The gateway 204 may include, for example, a modem configured to communicate with the termination system at the central location 103.

The gateway 204 may be connected to a variety of devices within the home, and may coordinate communications among those devices, and between the devices and networks outside the home 102. For example, the gateway 204 may include a modem (e.g., a DOCSIS device communicating with CMTS in an example of a n HFC-type network), and may offer Internet or other network connectivity to one or more devices within the home. The connectivity may also be extended to one or more wireless routers. For example, a wireless router may be an IEEE 802.11 router, local cordless telephone (e.g., Digital Enhanced Cordless Telephone—DECT), or any other desired type of wireless network. Various wireless devices within the home, such as a DECT phone (or a DECT interface within a cordless telephone) and portable laptop computer, may communicate with the gateway 204 using a wireless router.

The gateway 204 may also include one or more telephone interfaces, to allow the gateway 204 to communicate with one or more telephones. The telephones may be a traditional analog twisted pair telephone (in which case the gateway 204 may include a twisted pair interface), wireless telephone, or it may be a digital telephone such as a Voice Over Internet Protocol (VoIP) telephone, in which case the phone may simply communicate with the gateway 204 using a digital interface, such as an Ethernet interface.

The gateway 204 may communicate with the various devices within the home using any desired connection and protocol. For example, an in-home MoCA (Multimedia Over Coax Alliance) network may use a home's internal coaxial cable network to distribute signals to the various devices in the homes. Alternatively, some or all of the connections may be of a variety of formats (e.g., MoCA, Ethernet, HDMI, DVI, twisted pair, etc.), depending on the particular end device being used. The connections may also be implemented wirelessly, using local wi-fi, WiMax, Bluetooth, or any other desired wireless format.

The incoming line may also be connected to one or more network interface devices 205, which can be any processing, receiving, and/or displaying computing device, such as smart phones, tablets, display devices, set-top boxes (STBs), digital video recorders (DVRs), gateways, etc., that serve as a network interface between devices in the home and the network 101. The devices 205 may receive and decode content, and may provide that content to users for consumption, such as for viewing video content on a television 206. Alternatively, televisions, or other viewing devices 206, may be connected to transmission line 201 directly without a separate interface device, and may perform the functions of the interface device. Any type of content, such as video, video on demand, audio, Internet data etc., can be accessed in this manner. As an alternative, the interface device functionality can be incorporated with the gateway, so that the gateway 204 receives and decodes content from the line, and supplies it to the televisions for display using any desired local home physical interface.

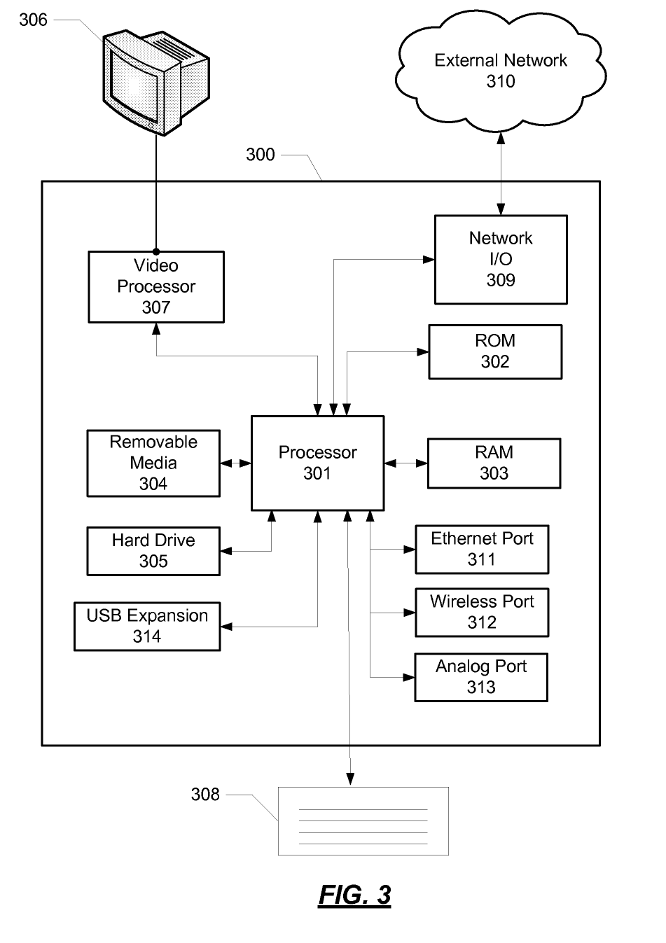

FIG. 3 illustrates a computing device 300 that may be used to implement the gateway 204 (and/or network interface device 205), although similar components (e.g., processor, memory, computer-readable media, etc.) may be used to implement any of the devices described herein. The device 300 may include one or more processors 301, which may execute instructions of a computer program to perform any of the features described herein. Those instructions may be stored in any type of computer-readable medium or memory, to configure the operation of the processor 301. For example, instructions may be stored in a read-only memory (ROM) 302, random access memory (RAM) 303, removable media 304, such as a Universal Serial Bus (USB) drive, compact disc (CD) or digital versatile disc (DVD), floppy disk drive, or any other desired electronic storage medium. Instructions may also be stored in an attached (or internal) hard drive 305.

The device 300 may include one or more output devices, such as a display 306 (or an external television connected to a set-top box), and may include one or more output device controllers 307, such as a video processor. There may also be one or more user input devices 308, such as a wired or wireless remote control, keyboard, mouse, touch screen, microphone, etc. The device 300 may also include one or more network input/output circuits 309, such as a network card to communicate with an external network 310. The network interface may be a wired interface, wireless interface, or a combination of the two. In some embodiments, the interface 309 may include a modem (e.g., a cable modem), and network 310 may include a television distribution system, such as a coaxial, fiber, or hybrid fiber/coaxial distribution system (e.g., a DOCSIS network).

The device 300 may include a variety of communication ports or interfaces to communicate with the various home devices. The ports may include, for example, Ethernet ports 311, wireless interfaces 312, analog ports 313, and any other port used to communicate with devices in the home. The gateway 204 may also include one or more expansion ports 314. The expansion ports 314 may allow the user to insert an expansion module to expand the capabilities of the gateway 204. As an example, the expansion port may be a Universal Serial Bus (USB) port, and can accept various USB expansion devices. The expansion devices may include memory, general purpose and dedicated processors, radios, software and/or I/O modules that add processing capabilities to the device 300. The expansions can add any desired type of functionality, several of which are discussed further below.

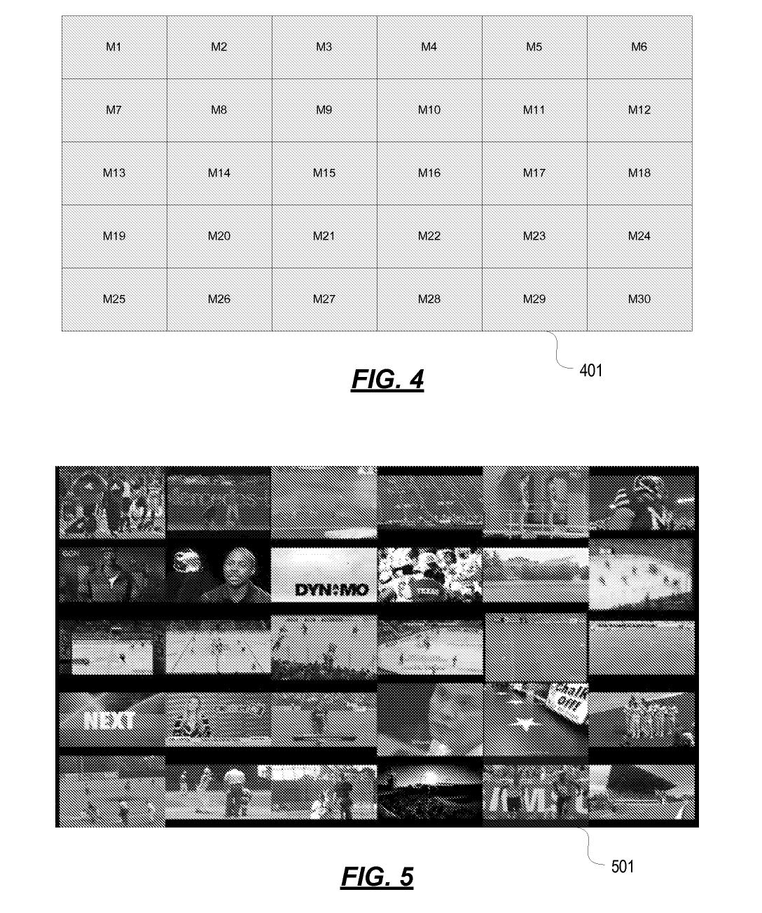

With further reference to FIG. 4, a central location 103 (e.g., a computing device in communication with content source 104) may compose and send a mosaic channel 401 over the content distribution system. For example, content source 104 may allocate a channel e.g., from a pool of allocated channels, and send to a content reception device information necessary to tune to the channel for any type of delivery, such as IP delivery, QAM delivery, a URL for IP delivery, etc. A mosaic channel can be any video content whose image has been subdivided into two or more regions, each of which concurrently carries a different (e.g., reduced size) video stream or program. Each video may be referred to herein as a video tile or a tile of the mosaic channel. The mosaic channel may further include audio for one or more of the video tiles, or for each of the video tiles, and a receiving decoder/tuner can thereby play audio for any one or more desired video tiles. As shown in FIG. 4, example mosaic channel 401 includes 30 video tiles M1-M30, each of which depicts a reduced size of a respective video program. When a mosaic channel is transmitted at 1280×720 pixel resolution containing 30 thumbnail videos for example, each video tile may be 213×144 pixels. If the mosaic is generated at 1920×1080, then the mosaic could either contain 63 thumbnails of 213×144 pixels, or some other number of video tiles at a different resolution. FIG. 5 illustrates example screenshot of a mosaic channel 501 according to the layout depicted in FIG. 4.

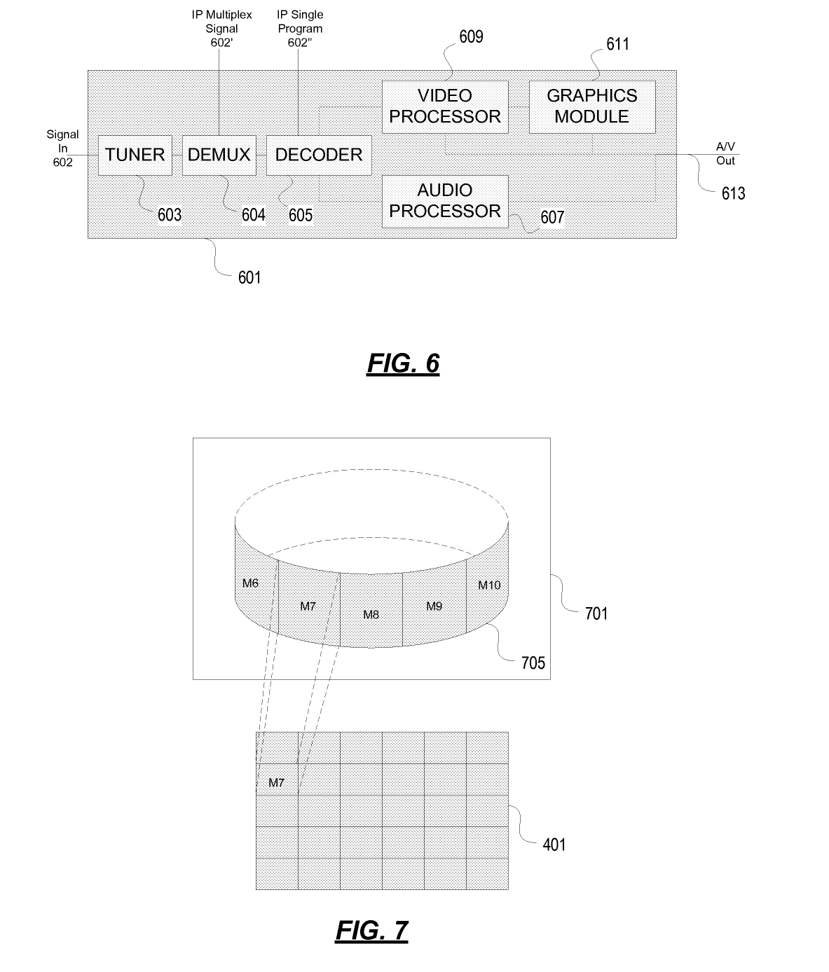

FIG. 6 illustrates a block diagram of an example content reception device 601 (e.g., device 204, 205, 300) adapted to receive mosaic channel 401. Device 601 may include additional or different components and modules to perform additional services (e.g., security, networking, I/O, etc.), which are not shown. For example, device 601 may receive the signal 602 from the central location 103, and initially process the signal through a tuner 603 to isolate a particularly desired carrier frequency and extract its modulated data stream. The tuner may lock to the appropriate carrier frequency and extract the modulated data stream. In embodiments using a digital cable system this data stream may be an MPEG transport stream. The MPEG transport stream is the input to the DEMUX which extracts from the transport stream the elementary program streams for the desired service. In embodiments using delivery via IP video the tuning phase may be omitted and the IP delivered data stream 602′ may be fed directly to the DECODER (or to DEMUX if it is known that the data stream contains a multiplex rather than a single program).

The extracted data stream (or multiplexed IP data stream) is sent to demultiplexer 604 to isolate a particularly desired channel, e.g., mosaic channel 401. The isolated channel is sent to decoder 605 for decryption and processing. A single program received via IP data stream 602″ may be fed directly to decoder 605. Device 601 may be adapted with multiple tuners/decoders (not shown). Decoder 605 may further split the channel into a video portion and an audio portion, and forward each portion to video processor 609 and audio processor 607, respectively. Audio processor 607 may select and process an audio component corresponding to a desired video tile (further discussed below) and output the audio through A/V Out 613 to a display device or other speaker system. Video processor 609 may process a channel for output through 613 into a form usable by a display device. In addition, or alternatively, video processor 609 may output individual frames of the channel 401 to graphics module 611. Graphics module 611 may be adapted or configured with information usable to isolate any particular mosaic tile on a video frame.

For example, device 601 (or graphics module 611) may be configured in advance with information in memory (e.g., received from the central location, headend, etc.) regarding the layout of mosaic channel 401, namely, that in this example mosaic channel 401 includes 30 tiles corresponding to specific programs (e.g., series, episode, length, channel, etc.) in predetermined locations within the mosaic and having predetermined resolutions. In one embodiment, graphics module 611 may further be configured to render images in a simulated three-dimensional environment, e.g., using OpenGL or other 3D graphics rendering hardware and/or software. Graphics module 611 may render images at 12 frames per second (fps), 15 fps, 30 fps, or some other desired amount based on the capabilities of the chipset in use in device 601. Thus, when graphics module 611 is rendering the display at 15 fps or higher by using still images from mosaic channel 401, 501, a display is made to appear with multiple full motion videos being shown simultaneously, when each of the videos was in fact received over a single channel using only a single tuner. Device 601 may further instruct audio processor 607 to isolate and play audio for a mosaic tile displayed with prominence (compared to other mosaic tiles) in a currently showing video image (e.g., on a television via video out 613).

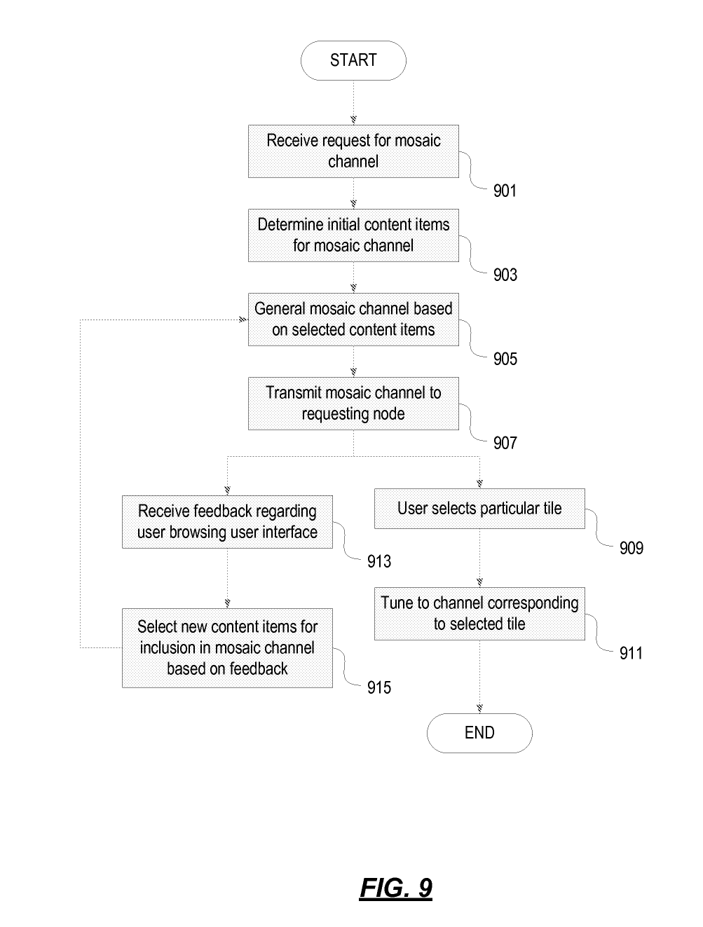

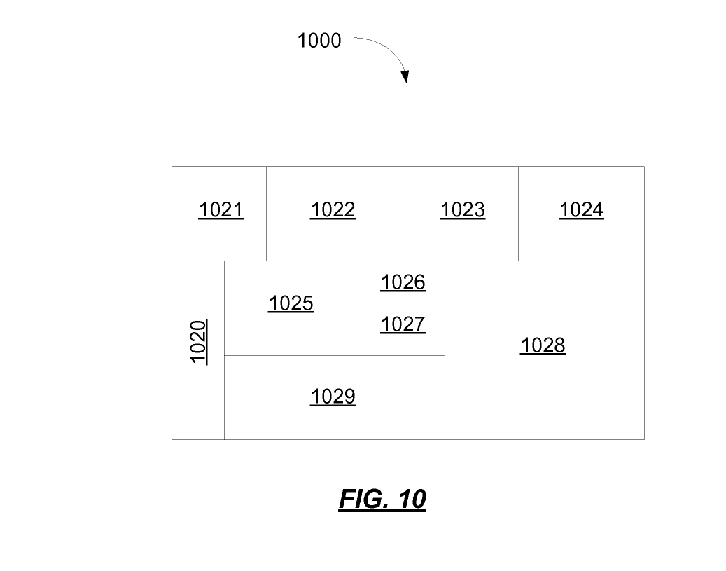

FIG. 7 illustrates mapping a video tile as a texture of a surface of a polygon in a simulated three dimensional space. According to the disclosure, a computing device may use a video tile from a mosaic channel as a texture for mapping onto a polygon in a simulated 3D user interface display. By performing texture mapping at a high rate, the surface of the polygon will appear to have full motion video on it. A device, such as graphics module 611, may copy a video tile (e.g., the M7) out of a frame of the mosaic channel 401 and use that video tile as a texture for mapping to a control element 705 (or portion of control element 705) usable as a navigable menu in a simulated 3D visual environment, that may be rendered on a display screen 701. Control element 705 may be comprised of one or more polygons in a simulated 3D space. A user may in turn manipulate and navigate control element 705 (e.g., by rotating the control element using arrow keys on a remote control device) to select a desired video (or another data or content) to watch or use. In the example shown in FIG. 7, control element 705 may show five full motion videos at a time as a user rotates videos into and out of view. Audio processor 607 or a similar device may be configured to play audio corresponding to whichever mosaic tile is presently shown in the centered position which, in the example of FIG. 7, corresponds to tile M8. As the user rotates control element 705 using navigation buttons on a remote control, device 601 may sequentially map video tiles onto control element 705 to provide an endless loop of content. Alternatively, content received in the mosaic channel may be changed as the user navigates, as further discussed with respect to FIG. 9 below. Textures for portions of the user interface may also be stored in memory of a local device, e.g., for non-video display elements such as buttons, controls, and the like.

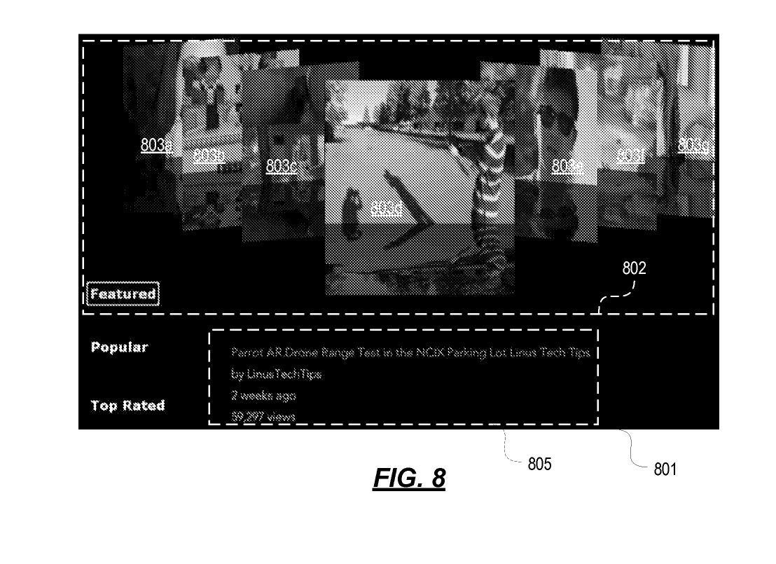

FIG. 8 illustrates a sample display, such as a video rich display 801, according to an illustrative aspect described herein. Video rich display 801 includes multiple video images 803a-803g. Each image 803a-803g may correspond to one tile in video mosaic 401, 501. That is, each tile 803a-803g concurrently displays a playing or moving video, not merely a static image as is depicted in FIG. 8. A user, using an input device such as a remote control, mouse, keyboard, etc., can control the display to move the videos left and right on a control element 802 of the user interface. Display 801 may include further information 805 regarding whichever video is in the center (in this example, video 803d). Device 601, and audio processor 607, may further be configured to cause audio associated with the video in the center to be output to one or more speakers. When the user selects a particular video, e.g., by pressing a “select” or similar key, device 601 may tune to a channel corresponding to a full screen or full resolution version of the selected mosaic tile, and render the audio and video for full-screen output on the display (e.g., on the TV).

According to various aspects described herein, the mosaic channel may be comprised of a predetermined selection of video tiles, a user-selected selection of video tiles, and/or a user-based selection of video tiles. That is, tiles arranged pursuant to any devices recommendation method, the video programs included as video tiles in the mosaic channel may be selected by a content provider, may be selected by a user, may be selected based on user configuration information, or may be based on a combination of these. In one embodiment there may be one or more predefined mosaic channels that a receiving device 601 may tune to based on predefined channel map information previously communicated to receiving device 601 as would be communicated channel information regarding any other channel in a content distribution system. For example, channel Mosaic-1 may include video tiles of the n most popular channels; Mosaic-2 may include video tiles of the n most popular sports channels; Mosaic-3 may include video tiles of the n most popular lifestyle channels; Mosaic-4 may include video tiles of the n most popular videos from a particular media publisher (or any other content provider); etc. Each receiving device may tune to a desired frequency or channel and configure a user display based on the static list of video tiles in each mosaic stream, as described above.

According to another aspect, with reference to FIG. 9, one or more mosaic channels may be dynamic mosaic channels whose content may change or be dynamically altered based on user-input and/or user-preferences. In step 901, a request may be received from a device for a mosaic channel. The requesting device may be a user device, or another network device.

Next, in step 903, the device or entities (e.g., content provider) receiving or acting upon the request may select n channels for inclusion in a mosaic channel, where n is the number of tiles in the mosaic channel. According to one aspect, a content provider may select predetermined content items for inclusion in the mosaic channel. In another aspect, the provider or publisher may select shows based on user input identifying a desired type or genre of shows, or shows having certain characteristics (e.g., popular shows, most recently viewed channels, sports, comedies, reality TV, from a particular content source, etc.). The provider may then retrieve or otherwise provide access to content meeting the selected type, genre, or other characteristics.

In step 905, a computing device such as an encoder may generate the mosaic channel, e.g., using an assignment server to assign locations within the mosaic channel for each video content, and may communicate content or other associated metadata (e.g., content name, description, location within mosaic stream, etc.) therewith.

In step 907 the central location transmits the mosaic channel to the requesting device 601 or another network-appropriate point, such as a node. Mosaic channels may be transmitted to devices using any known (or developed) transmission technique, e.g., as part of an MPEG transport multiplex that is IP or QAM encoded and delivered over any distribution network (e.g., an MPEG stream accessible over IP video). Further, the mosaic channel may be stored as a file on a local or networked file system, and retrieved by the requesting device based on a communicated universal/uniform resource locator (URL).

When a requesting device begins receiving the mosaic channel and presenting a video rich user interface to a user, e.g., as shown in FIG. 7 and FIG. 8, several things may happen. As shown in step 909, a user may select a video tile for viewing. Selecting a video tile for viewing is different from merely navigating the video rich user interface such that a particular video tile has focus. Selecting a particular video tile indicates a user's desire to tune to a channel, start on-demand content, or otherwise watch video content associated with that video tile in a regular display mode (e.g., full screen) on the viewing device. Next, in step 911, the receiving device 601 may tune to the corresponding channel, on-demand stream, or otherwise cause the selected content to be played.

As a user navigates the video rich user interface, the receiving device may loop the video tiles so that the interface loops the video tiles back to the first video tile after the last video tile. The video rich user interface therefore appears to have an endless supply of video tiles, even though they in fact repeat. Alternatively, in step 913, as a user is navigating, receiving device 601 may send feedback to the central location via a backchannel or other upstream communication channel to indicate the user is nearing the last video tile. In one illustrative aspect, TCP/IP messages may be communicated over a DOCSIS communication system to provide such navigation feedback. In response, in step 915, the central location selects one or more new video tiles to insert into the mosaic stream in place of a corresponding number of video tiles previously included. The video tiles to be added may be selected based on the same or similar criteria as was initially used in step 903, or based on different criteria altogether. The video tiles to be removed may be selected based on those that the user has already previewed (i.e., seen in focus in the video rich user interface) and which are navigationally distant from the present focus of the video rich user interface.

The central location may then proceed back to step 905 to generate and deliver the revised mosaic channel, preferably in a manner seamless to the user, e.g., so that the user can continue navigating the video rich user interface without interruption. As the receiving device loops the video tiles so that the interface loops the video tiles back to the first video tile after the last video tile, the receiving device 601 is actually looping back to new content received on the modified mosaic channel to present a continuous supply of new video tiles. Stated differently, using backchannel feedback, the receiving device receives a dynamically generated mosaic channel that is altered by the content provider in real time responsive to user navigation of the video rich user interface in such a way as to display a continuous supply of video tiles in the video rich user interface using only a single tuner of the receiving device.

FIG. 10 illustrates a mosaic channel 1000 having a screen area that has been divided into multiple different sized onscreen locations in accordance with one or more features of the disclosure herein. In the example shown, a mosaic channel 1000 may be encoded to include a mosaic of ten different videos for rendering at different resolutions 1020-1029. Each video tile may correspond to a different viewing resolution, usable to general visually stimulating interactive video rich user interfaces. Any of a number of different (or same) sized tiles may be used. The same or different video content may be included on tiles of different resolutions, thereby alleviating resources required of the receiving device to resize a video tile if need be. In addition, tiles supplied with larger sizes may be used to display a video with higher visual quality. Hence, if the intended navigational control object, display screen, and/or display area using one or more tiles is such that certain tiles will be mapped onto larger display areas, visual quality may be enhanced if these tiles are received in a larger tile of a mosaic channel.

In any of the above aspects, any desired video content can be included in a mosaic channel. In one example, a receiving device might implement a game, interactive activity, or other video-based program that displays or makes use of multiple video tiles. The video tiles for use in the activity might be provided over a mosaic channel as described herein. The content and location of each video tile may be prearranged between the mosaic channel provider and the receiving device.

Other embodiments include numerous variations on the devices and techniques described above. Embodiments of the disclosure include a machine readable storage medium (e.g., a CD-ROM, CD-RW, DVD, floppy disc, FLASH memory, RAM, ROM, magnetic platters of a hard drive, etc.) storing machine readable instructions that, when executed by one or more processors, cause one or more devices to carry out operations such as are described herein.

The foregoing description of embodiments has been presented for purposes of illustration and description. The foregoing description is not intended to be exhaustive or to limit embodiments of the present disclosure to the precise form disclosed, and modifications and variations are possible in light of the above teachings or may be acquired from practice of various embodiments. Additional embodiments may not perform all operations, have all features, or possess all advantages described above. The embodiments discussed herein were chosen and described in order to explain the principles and the nature of various embodiments and their practical application to enable one skilled in the art to utilize the present disclosure in various embodiments and with various modifications as are suited to the particular use contemplated. The features of the embodiments described herein may be combined in all possible combinations of methods, apparatuses, modules, systems, and machine-readable storage media. Any and all permutations of features from above-described embodiments are the within the scope of the disclosure.

1. A method comprising:
generating a mosaic channel comprising a first plurality of tiles, each tile corresponding to video content;
generating a navigable user interface comprising a plurality of display areas;
mapping each of one or more of the plurality of tiles to a different one of the plurality of display areas; and
rendering the user interface in a simulated three dimensional graphical environment, wherein each of the plurality of display areas corresponds to a surface of a polygon within the simulated three dimensional graphical environment, to concurrently play the video content corresponding to the plurality of display areas.

2. The method of claim 1, further comprising outputting audio corresponding to a video in a primary focus location of the user interface.

3. The method of claim 1, further comprising:
sending feedback to a device associated with the mosaic channel, said feedback based on user navigation of the user interface; and
receiving a modified mosaic channel based on the sent feedback.

4. The method of claim 1, wherein the user interface comprises a three dimensional control object comprising the plurality of display areas in a predetermined sequence, and the method further comprises sequentially mapping the tiles to the sequenced plurality of display areas as the user navigates the three dimensional control object to allow the user to preview the plurality of video content.

5. The method of claim 4, further comprising looping mapping of the plurality of tiles to the plurality of display areas to provide endless display of video content on the three dimensional control object.

6. The method of claim 4, further comprising:
sending feedback to a device associated with the mosaic channel, said feedback based on user navigation of the user interface;
receiving a modified mosaic channel based on the sent feedback, said modified mosaic channel comprising one or more new video content replacing a corresponding one or more removed video content; and
when the user navigates to a last tile, mapping the tiles corresponding to the new video content to sequentially subsequent display areas, thereby providing new video content for preview by the user.

7. The method of claim 1, further comprising, prior to receiving the mosaic channel, receiving user input identifying a desired characteristic of video programs; and
generating the mosaic channel to include video content matching the desired characteristic.

8. The method of claim 7, wherein the desired characteristic is one of a genre, a popularity, and previously watched content.

9. The method of claim 1, wherein the number of display areas is no greater than the number of tiles.

10. A method comprising:
receiving a user request for a first mosaic channel;
generating a first mosaic channel responsive to the user request;
sending the first mosaic channel to a user-device from which the user request was initiated;
receiving a navigational feedback from the user-device as a user navigates video tiles of the first mosaic channel;
generating a second mosaic channel responsive to and based on the received navigational feedback; and
sending the second mosaic channel to the user-device in place of the first mosaic channel.

11. The method of claim 10, wherein the second mosaic channel comprises one or more video tiles not yet previewed by the user in place of corresponding one or more video tiles already previewed by the user.

12. The method of claim 10, wherein the user request for the first mosaic channel includes user input regarding a desired characteristic of video programs to be included in the first mosaic channel.

13. The method of claim 12, wherein the desired characteristic is one of a genre, a popularity, and previously watched content.

14. A device, comprising:
a processor;
a receiver module for receiving a mosaic channel via a media distribution network, said mosaic channel comprising a first plurality of tiles, each tile corresponding to a video content; and
a graphics module that generates a navigable user interface having a plurality of display areas, each display area displaying a different video content received in the mosaic channel.

15. The device of claim 14, wherein said graphics module generates the navigable user interface by performing:
mapping a different one of the plurality of tiles to each of the plurality of display areas;
rendering, in a frame output for display, the navigable user interface based on the mapping; and
repeating the mapping and rendering at a frame rate to produce the appearance of moving video.

16. The device of claim 15, wherein rendering comprises rendering the navigable user interface in a simulated three dimensional graphical environment, wherein each of the plurality of display areas corresponds to a surface of a polygon within the simulated three dimensional graphical environment.

17. The device of claim 14, further comprising an audio module configured to output audio corresponding to a tile mapped to a display area in a primary focus location of the navigable user interface.

18. The device of claim 14, further comprising a feedback module configured to send feedback to a device associated with the mosaic channel, said feedback based on user navigation of the user interface,
wherein the receiver is configured to receive a modified mosaic channel based on the sent feedback.

19. The device of claim 18, wherein the modified mosaic channel comprises one or more new video content replacing a corresponding one or more removed video content, wherein said removed video content are selected based on video content already displayed in the navigable user interface.

20. The device of claim 18, wherein said feedback module is further configured to, prior to receiving the mosaic channel, receive user input identifying a desired characteristic of video content,
wherein said mosaic channel includes video content matching the desired characteristic.
